(19) United States
(12) Patent Application Publication
(10) Pub. No.: US 2018/0304595 A1
(43) Pub. Date: Oct. 25, 2018

(54) Multilayer Plastic Film with Heat Resistant Outer Layers and Slow and Normal Crystallizing Polyamides

(71) Applicant: Macro Technology Inc., Mississauga (CA)

(72) Inventors: Miroslav Planeta, Mississauga (CA); Harinder Tamber, Brampton (CA)

(21) Appl. No.: 15/768,268

(22) PCT Filed: Oct. 14, 2016
(86) PCT No.: PCT/CA2016/051196

§ 371 Date: Apr. 13, 2018

Related U.S. Application Data
(60) Provisional application No. 62/242,022, filed on Oct. 15, 2015.

(51) Int. Cl. B32B 27/08; B32B 27/36; B32B 27/34; B32B 27/32; B32B 27/30; B32B 7/02; B32B 38/00

(52) U.S. Cl. CPC B32B 27/08; B32B 2367/00; B32B 27/34; B32B 27/322; B32B 27/304; B32B 27/325; B32B 27/32; B32B 27/306; B32B 27/308; B32B 7/02; B32B 38/0036; B32B 2250/05; B32B 2307/7244; B32B 2307/7246; B32B 2250/24; B32B 2307/704; B32B 2307/736; B32B 2439/40; B32B 2439/60; B32B 2038/0048; B32B 2323/04; B32B 2325/00; B32B 27/36

(57) ABSTRACT

A multilayer film is herein provided. The film, which is useful for packaging, comprises: —a core barrier layer having an outer side and an inner side, said core barrier layer comprising one or more barrier polymers that exhibit moisture and/or oxygen barrier properties, wherein said barrier polymer is optionally coupled to a slow crystallizing polyamide or a polymer blend thereof; —an outer layer bonded to the outer side of the core barrier layer comprising a rigid polymer having an inherent viscosity (IV) in the range of about 3.2 to 4.7, wherein the outer layer optionally comprises slow crystallizing polymer (SCP) or a polymer blend thereof; and —a sealant layer bonded to the inner side of the core barrier layer comprising one or more polyolefins sufficient to provide a seal.

### FIELD OF THE INVENTION

The present application generally relates to the field of multilayer plastic films, and in particular, relates to multilayer plastic films with high oxygen barrier or high moisture barrier or improved mechanical properties.

### BACKGROUND OF THE INVENTION

Multilayer high & low shrink plastic films have use in areas such as food, medical and industrial packaging. Specifically for food packaging, to maintain freshness, colour, and other properties, the multilayer high shrink plastic films must create a barrier against moisture, gases (such as oxygen), and aroma. In addition, the multilayer high shrink plastic film should have mechanical properties such as puncture resistance, including tear and tensile strength. These properties prevent packaged food from damage during processing and transport.

U.S. Pat. No. 5,336,549 describes a multilayer heat shrinkable plastic film comprised of core layers of ethylene vinyl alcohol (EVOH) and polyamide (PA) surrounded by a thin polyethylene terephthalate (PET) outer layer and a thin adhesive layer. Although the core layers of EVOH and PA have high oxygen barrier properties (EVOH) and high mechanical properties (PA), the outer PET layer and adhesive layer have low moisture barrier properties. As a result, moisture is able to permeate the outer layers at three different stages during processing exposing the core layers of EVOH and PA to moisture, leading to an increased oxygen transmission rate and accordingly, a deterioration of the oxygen barrier and mechanical properties of the film.

U.S. Pat. No. 5,079,051 discloses polyvinylidene chloride (PVDC) which functions as both an oxygen and moisture barrier. However, under dry conditions (low relative humidity), oxygen barrier properties of PVDC are less than the oxygen barrier properties of EVOH. In addition, PVDC is difficult to process on larger dies.

US Patent Application US2010/0003432A1 and EU Patent EP 2351645A1 (Schiffmnan) disclose thermoplastic materials of different thicknesses surrounding nylon-based barrier layers around core layers of EVOH and/or PA. These thermoplastic materials include polypropylene (PP), polyethylene (PE), polystyrene (PS), and poly(ethylene terephthalate)-glycol (PETG). However, these materials have low moisture barrier properties, leading to exposure of moisture to the barrier layers. Since oxygen transmission rate of barrier layers such as nylon/EVOH is dependent on relative humidity, a high relative humidity results in an increase in oxygen transmission (decrease in the oxygen barrier properties of EVOH) and a decline in mechanical properties provided by nylon barrier layers.

To increase moisture barrier properties, the percentage of polyolefin (PO) may be increased within the layers of a film, however, an uneven increase in PO may result in an asymmetrical film structure leading to curling and orientation issues of a multilayer film. In other cases, as disclosed in Schiffman, the EVOH layer may be protected with a blend of cyclic olefin copolymer (COC) and PE on one side of the film since COC is a rigid material. However, in this case, the other side of the film is protected with a PE-based sealant layer, increasing the risk of moisture exposure to the EVOH/Nylon core.

U.S. Pat. No. 8,012,572 describes a micro-layer film comprising alternating micro-layers of EVOH/PA6. While this may provide more flexibility, both of these materials are hydrophilic and can absorb moisture, which reduces the oxygen barrier and mechanical properties of the film.

Prior multi-layer films exhibit drawbacks with respect to mechanical and barrier properties. At the outset, the fabrication of multilayer films, including layers of Nylon/EVOH or Nylon/EVOH/Nylon, such as those described above, via the double or triple bubble process, can lead to films which exhibit a loss in mechanical and barrier properties. It addition, although EVOH and nylon provide oxygen barrier (EVOH) and mechanical strength (Nylon) properties, these polymers are hydrophilic, and this results in reduced oxygen barrier and mechanical properties of the resulting film when exposed to moisture.

Thus, there is a need for a multi-layer film which overcomes at least one of the disadvantages of prior multi-layer films.

### SUMMARY OF THE INVENTION

An improved multilayer film is herein provided.

In one aspect, the multilayer film comprises
a core barrier layer having an outer side and an inner side, said core barrier layer comprising one or more barrier polymers that exhibit moisture and/or oxygen barrier properties, wherein said barrier polymer is optionally coupled to a slow crystallizing polyamide or a polymer blend thereof;
an outer layer bonded to the outer side of the core barrier layer comprising a rigid polymer having an inherent viscosity (IV) in the range of about 3.2 to 4.7, wherein the outer layer optionally comprises slow crystallizing polymer (SCP) or a polymer blend thereof; and
a sealant layer bonded to the inner side of the core barrier layer comprising one or more polyolefins sufficient to provide a seal.

This and other aspects of the invention are described by reference to the detailed description that follows and the drawings.

### BRIEF DESCRIPTION OF THE DRAWINGS

FIG. 1 graphically compares the properties of a slow crystallizing polymer (SCP) to a normal crystallizing polymer (NCP);

FIG. 2 is a schematic drawing showing the production of biaxially oriented heat shrinkable multilayer plastic film in accordance with one embodiment of the invention by means of a double bubble blown process;

FIG. 3 is a schematic drawing showing the production of biaxially oriented heat shrinkable multilayer plastic film in accordance with one embodiment of the invention by means of a double bubble blown process with annealing;

FIG. 4 is a schematic drawing showing the production of multilayer plastic film in accordance with one embodiment of the invention by means of a cast film process;

FIG. 5 is a schematic drawing showing the production of multilayer plastic film in multilayer blown form; and

FIG. 6 is a schematic showing lamination of a multilayer plastic film.

### DETAILED DESCRIPTION OF THE INVENTION

A novel multi-layer film is provided. The multilayer film comprises a core barrier layer having an outer side and an inner side, said core barrier layer comprising one or more barrier polymers that exhibit moisture and/or oxygen barrier properties, wherein said barrier polymer is optionally coupled to a slow crystallizing polymer or polymer blend thereof; an outer layer comprising at least one rigid polymer having an inherent viscosity (IV) in the range of about 3.2 to 4.7 which is bonded to the outer side of the core barrier layer; and a sealant layer comprising one or more polyolefins sufficient to provide a seal bonded to the inner side of the core barrier layer.

The multilayer film comprises a core barrier layer having an outer side and an inner side. The outer layer of the multilayer film is bonded to the outer side of the core barrier. The outer layer will generally comprise a heat resistant polymer having a melting point in the range of 190° C. to 265° C. Suitable polymers are rigid polymers having an inherent viscosity (IV) in the range of about 3.2 to 4.7. Examples of polymers for inclusion in the outer layer include polychlorotrifluoroethene (PCTFE) or polyvinylidene fluoride (PVDF) or PVDF copolymers (such as PVDF-hydrofluoroethene (HFE)), which provide a barrier to moisture to protect inner layers. The outer layer may also be a thermoplastic polymer or blend of polymers including polyesters, e.g. polyethylene terephthalate (PET), e.g. PET with a melting point of above 250° C., polyethylene terephthalate glycol-modified (PETG), PET/PETG, low density polyethylene (LDPE), linear low density polyethylene (LLDPE), metallocene-based linear low density polyethylene (MLLDPE), polypropylene (PP), copolymers of polypropylene, high-density polyethylene (HDPE), ionomers, PETG/PET, polyolefin (PO), polystyrene (PS), styrene butadiene copolymer, poly(methylmethacrylate) (PMMA), amorphous polyethylene terpthalate (APET), polyethylene naphthalate (PEN), polybutylene terephthalate, PLA (polylactic acid), COC, polyolefin, blends of COC with polyolefin, PE or PP (homopolymer or copolymers), PET or PETG to provide moisture barrier properties, nylons (polyamide polymers) such as nylon-6,6 having a melting point of about 250° C.; nylon-6 having a melting point of about 220° C.; nylon-6 (SCP—slow crystallizing polymer), blends of nylon-6 (SCP) with normal nylon crystallizing polymer (NCP) such as nylon (SCP) 99.5-0.5 wt % to nylon-6 (NCP) 0.5-99.5 wt %, nylon blends such as a blend of nylon-6 with nylon-6,6, a blend of nylon-6 with nylon-6,12 or nylon 6/66 copolymer with a melting point of about 190° C. to about 195° C.; nylon 6,10; nylon 6,12; nylon terpolymer, nylon 11; nylon 12; nylon 6,9; nylon 4,6; aromatic nylon (MDX6); amorphous nylon, and mixtures thereof. It should be noted that in nylon-6 SCP-NCP blends, NCP may be nylon-6, nylon-6,6, nylon-6/66, nylon-11, nylon-12, nylon-4,6, nylon 6/9, nylon-6/10, nylon 6/12, nylon terpolymer, aromatic nylon and amorphous nylon.

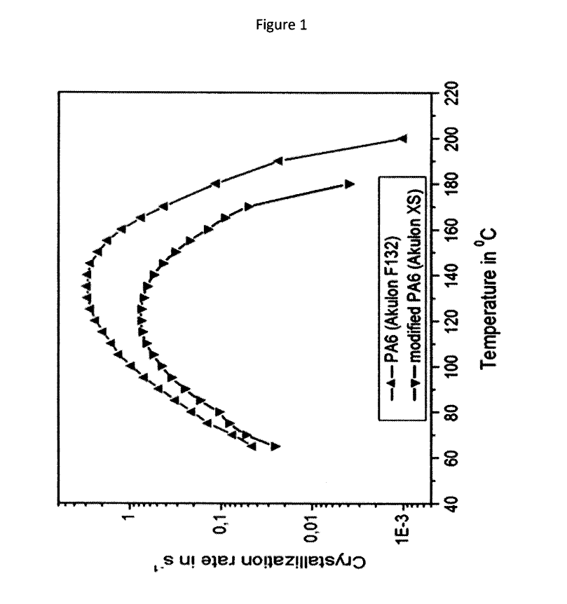

The term “slow crystallizing polymer” refers to a polyamide (e.g. Nylon 6) which crystallizes more slowly than the “normal” crystallization time for the same polymer, while retaining the same % crystallinity and barrier properties, as shown in the data of FIG. 1 provided by the supplier (DSM). The polymer is modified during polymerization to achieve a slower rate of crystallization. An example of a slow crystallizing polymer is Akulon™ XS, e.g. nylon-6.

Alternatively, the outer layer may comprise at least two different polymers, or microlayers of at least two different alternating polymers, a rigid polymer and a soft polymer. The rigid polymer is a polymer having an inherent viscosity (IV) in the range of about 3.2 to 4.7 (96% sulfuric acid, 1 g/100 ml) and a melting point in the range of about 190° C. to 265° C. Examples of suitable rigid polymers include, but are not limited to, thermoplastic polymers such as polyesters, e.g. polyethylene terephthalate (PET), e.g. PET with a melting point of above 250° C., polyethylene terephthalate glycol-modified (PETG), high density polyethylene (HDPE), PETG/PET, polyolefin (PO), polypropylene (PP), amorphous polyethylene terpthalate (APET), polyethylene naphthalate (PEN), polybutylene terephthalate (PBT), PLA (polylactic acid), COC, polyolefin, blends of COC with PE or PP (homopolymer or copolymers), polychlorotrifluoroethene (PCTFE), polyvinylidene fluoride (PVDF) and PVDF with hydrofluoroethene (HFE), nylons (polyamide polymers) such as nylon-6,6 having a melting point of about 250° C.; nylon-6 having a melting point of about 220° C.; nylon-6 (SCP—slow crystallizing polymer), blends of nylon-6 (SCP) with nylon-6 (NCP—normal crystallizing polymer) such as nylon (SCP) 99.5-0.5 wt % to nylon-6 (NCP) 0.5-99.5 wt/o, nylon blends such as a blend of nylon-6 with nylon-6,6, a blend of nylon-6 with nylon-6,12 or nylon 6/66 copolymer with a melting point of about 185° C. to about 195° C.; nylon 6,10; nylon 6,12; nylon terpolymer; nylon 11; nylon 12; nylon 6,9; nylon 4,6; aromatic nylon (MDX6); amorphous nylon, and mixtures of any of these polymers.

The soft polymer, having a melt index of from about 0.5 MI to 6 MI, may comprise, for example, maleic anhydride grafted onto linear low density polyethylene (LLDPE), low density polyethylene (LDPE), ethylene vinyl acetate (EVA) or EMA (ethylene methacrylate), optionally blended with polyolefin such as polypropylene, polyethylene, LLDPE, metallocene LLDPE (mLLDPE), high density polyethylene (HDPE), COC, plastomers or elastomers. Examples of suitable “soft” layers (also known as “tie” layers) include, but are not limited to, ethylene vinyl acetate-maleic anhydride copolymer, ethylene vinyl acetate-maleic anhydride, ethylene methyl acrylate-maleic anhydride, LDPE-maleic anhydride, or LLDPE-maleic anhydride. For example, the soft or tie layer may comprise ethylene-vinyl acetate copolymer with a melt index about 0.1 to about 6.0 decigram per minute and vinyl acetate content of from 9 to about 28 percent by weight. The polymers in the soft or tie layers may be partially cross-linked prior to inclusion in the film. In one embodiment, the tic layer may be combined with PA (nylon) layers to form a microlayer structure such as PA1-tie-PA2-tie-PA3-tie.

The total thickness of the outer layer is in the range of from about 0.5 to about 10 microns, preferably from about 1 to 9 microns, and more preferably from about 2 to about 5 microns. If the outer layer comprises microlayers, it may comprise from 3 to about 60 microlayers of two or more different polymers, each microlayer being at least about 0.1 microns thick. Preferably, the outer layer comprises two different materials of 4 to 50 microlayers, and more preferably, 4 to 20 microlayers. In one embodiment, the outer layer may comprise from 2 to 30 microlayers of rigid polymer alternating with 2 to 30 microlayers of soft polymer.

The provision of a soft polymer layer alternating with a rigid polymer in the outer layer cushions the core of the multilayer film, thereby providing a more flexible core which is less prone to flex cracking that results in loss of barrier and mechanical properties. Thus, the outer layer provides strength, abuse resistance, gloss, and printability to the multi-layer film.

The outer layer may be bonded to the outer side of the core barrier via an optional bulk layer, either by a soft layer of the outer layer of the film or by inclusion of an additional tie layer. The bulk layer comprises one or more polyolefins having a density in the range of about 0.88 g/cc to 1.04 g/cc, and a melt index (MI) of from about 0.5 MI to 10 MI, preferably from about 1.0 MI to 6 MI, such as elastomers, plastomers, polypropylene homopolymer, copolymer, or terpolymer; styrene-based copolymers, polystyrene, styrene block copolymer (SBC), low density polyethylene (LDPE), cyclic olefin copolymer (COC), acid polymers, high density polyethylene (HDPE), linear low density polyethylene (LLDPE), metallocene LLDPE (mLLDPE), very low density polyethylene (VLDPE), metallocene polyethylene (mPE), high density polyethylene (HDPE), single site metallocene catalyst (SSC) based LLDPE, ethylene-vinyl acetate (EVA), ethylene methacrylate (EMA), octene-LL, hexene-LL, butene-LL, ionomers, and blends of any of these polymers. For example, the bulk layer may comprise 2 polymers such as LLDPE/EVA or LLDPE/elastomer. As one of skill in the art will appreciate, the polymers of the bulk layer may be partially cross-linked prior to processing (to improve shrink properties), and/or partially irradiated.

The bulk layer has a thickness in the range of about 1 to 50 microns, preferably between 2 to 25 microns, more preferably from 2 to 5 microns. The bulk layer may also comprise nanolayers, e.g. about 60-400 nanolayers, each nanolayer being at least about 0.01 microns in thickness, or micro-layers of at least about 0.1 microns thick).

The bulk layer (or outer layer if there is no bulk layer) is bonded to the outer side of the barrier core layer, optionally with a tie layer as described. The barrier core layer provides either moisture or oxygen barrier properties, or both. Accordingly, the core comprises one or more polymers that exhibit moisture barrier properties (e.g. an OTR below 6 cc·mil/100 in2·day·atm @73·F and 0% RH) and/or oxygen barrier properties (e.g. an MVTR below 1.0 g·mil/100 in2·day @ 100·F and 90% RH), such as a polyamide, EVOH or polyvinylidene chloride (PVDC) (e.g. having an ethylene content from 24 to 50 mole %, preferably from about 29% to about 44%, with over 98% saponification and a melt index (MI) of from about 0.5 MI to 10 MI, preferably from about 1.6 MI to 6 MI) as shown in Table 1.

TABLE 1
Oxygen and Moisture Barrier Properties

| MATERIAL | OTR | WVTR |
|---|---|---|
| LDPE | 420-450 | 1.1-1.5 |
| POLYPROPYLENE^{a} | 160-280 | 0.5-0.9 |
| HDPE^{b} | 150-290 | 0.4-0.9 |
| COC^{c} | — | 0.06-0.14 |
| PET | 200-250 | 5.0-6.0 |
| NYLON 6 | 2.2-5.0 | 18.0-23.0 |
| NYLON 6/66 | 2.2-5.0 | 18.0-23.0 |
| PVdF-copolymer | — | 0.2-0.4 |
| Barex 210^{d} | 0.7-0.8 | 5.0-6.0 |
| EVOH-32^{e} | 0.02-0.05 | 1.4-1.8 |
| PVdC (vdc/ma)^{f} | 0.05-0.07 | 0.03-0.05 |

OTR: cc · mil/100 in² · day · atm @73° F. and 0% RH
WVTR: g · mil/100 in² · day @ 100° F. and 90% RH
^{a,b}Low Oxygen barrier (OTR), medium moisture vapor barrier (WVTR)
^{c}Low Oxygen barrier (OTR), but high moisture vapor barrier (WVTR)
^{d}High Oxygen barrier (OTR), OTR is ‘independent of Relative humidity’ (RH),
^{e}High oxygen barrier (OTR), but OTR is ‘dependent on Relative humidity’ (RH).
^{f}High oxygen barrier (OTR), OTR is ‘independent of Relative humidity’ (RH), and high moisture vapor barrier (WVTR).
Please note:
Nova' Chemical's, HDPE SURPASS HPs167, TDS reports for 1.5 mil film, OTR 30 cm3/100 in 2/day, WVTR 0.07 g/100 in2/day. All other reported data in the above table is for 1 mil film as supplied by resin suppliers.

In one embodiment, the barrier core layer is an EVOH layer comprising hydrolyzed ethylene-vinyl acetate copolymer (saponification of up to or greater than 98%) with an ethylene content from about 27 to 48 mole percent. The barrier core may include a combination of polymers, for example, to achieve both oxygen and moisture barrier properties, and may include micro- or nano-layers of polymers. Tie layers may be included to bond different polymers within the barrier together. The thickness of the barrier core layer may be in the range of from about 1 micron to 25 microns, more preferably 2 to 10 microns. Examples of barrier cores include PVDC/tie/PVDC or PVDC/tie/EVOH/tie/PVDC.

The barrier core may include additional polymer components such as slow crystallizing polyamide polymer (PA(SCP)), or a blend of PA(SCP) with PA (NCP) such as PA-6, PA-6,66, PA-6,6, PA-11, PA-12, PA-6,10, PA-6,12, PA-4,6, aromatic PA, amorphous PA or PA terpolymer. The thickness of each SCP layer may be from about 2 to about 20 microns, preferably from about 3 to 15 microns, or from about 4 to 10 microns.

The inner side of the barrier core is optionally bonded to a shrink layer, optionally with a tie layer as described. The shrink layer comprises one or more polyolefins having a density of 0.88 g/cc to 0.92 g/cc, and may exhibit at least about 10% to 50% shrinkage at 90° C., such as elastomers, plastomers, polypropylene copolymer, or terpolymer; or a blend of low density polyethylene (LDPE), linear low density polyethylene (LLDPE), metallocene LLDPE (mLLDPE), very low density polyethylene (VLDPE), metallocene polyethylene (mPE), single site metallocene catalyst (SSC) based LLDPE, ethylene-vinyl acetate (EVA), ethylene methacrylate (EMA), PP copolymer, PP terpolymer, acid polymers, network polymers, ionomers with a melt index (MI) of from about 0.5 MI to 10 MI, preferably from about 1.0 MI to 6 MI, or an appropriate blend thereof (e.g. LLDPE/EVA or LLDPE/elastomer). The shrink layer may comprise micro-(10-60 microlayers) or nano-layers (60-400 nanolayers). To improve shrink characteristics, the polymers utilized in the shrink layer may be partially cross-linked prior to processing.

The shrink layer may have a thickness in the range of about 1 to 50 microns, preferably between 2 to 25 microns, and more preferably from 3 to 10 microns;

The shrink layer (or inner side of the core barrier layer, if no shrink layer is included) is bonded to an inner sealant layer, optionally with a tie layer. The sealant layer is the interior layer of the multi-layer film, i.e. the layer that is adjacent to the product being packaged or enrobed by the multi-layer film. The sealant layer comprises one or more polyolefins sufficient to provide a seal, e.g. having a seal strength from about 2 to 20 lbs/inch and a density of 0.88 g/cc to 0.920 g/cc, such as elastomers, plastomers, polyethelene (PE), polyolefin (PO), polypropylene homopolymer, copolymer, or terpolymer; or a blend of low density polyethylene (LDPE), medium density polyethylene (MDPE), linear low density polyethylene (LLDPE), metallocene LLDPE (mLLDPE), very low density polyethylene (VLDPE), metallocene polyethylene (mPE), high density polyethylene (HDPE), single site metallocene catalyst (SSC) based LLDPE, ethylene-vinyl acetate (EVA), ethylene methacrylate (EMA), ethyelene acrylic acid (EAA), ethylene methacrylic acid, ethylene methyl acrylate copolymer (EMAC), salts of ethylene acrylic acid or methacrylic acid, acid co-polymers, ionomers with a melt index (MI) of from about 0.5 MI to 10 MI, preferably from about 1.6 MI to 6 MI, PP homopolymers, copolymers, and terpolymers, and appropriate blends of any of these. In one embodiment, the sealant layer may comprise linear low density polyethylene with a melt index of from about 0.5 to about 6.0 decigram per minute, e.g. LLDPE (0.916 to 0.965 g/cc) density with appropriate blends of 0.88 g/cc to 0.918 g/cc) of LLDPE, mLLPDE, plastomer, elastomers, EVA (VA 0.5% to 33%), EMA or ionomer. The polymers utilized in the sealant layer may be partially cross-linked prior to processing.

The sealant layer may also comprise nano- or micro-layers of suitable polymers. The sealant layer has a thickness in the range of about 5 to 50 microns, preferably between 15 to 25 microns.

As will be appreciated by one of skill in the art the various layers of the present film may be bonded together with a tie layer as described above. Thus, the outer layer may be bonded to the bulk or core barrier layers with a tie layer, the bulk layer may be bonded to the core barrier layer with a tie layer, the core barrier layer may be bonded to the shrink or sealant layers with a tie layer, and the shrink and sealant layers may be bonded with a tie layer. The tie layer may be 2-20 microns thick. Micro- or nano-layers may also be bonded with tie layers.

The present multi-layer film has a total thickness of from about 10 to about 300 microns, preferably a thickness of from about 25 to about 150 microns, and more preferably, a thickness of from about 25-100 microns. The films may have from 9 to 400 or more layers. The multi-layer film may exhibit shrinkage from about 5% to 40% at 90° C. A multilayer sheet comprising the present films may have a total thickness of 5 mil to 200 mil (100-5000 microns), and preferably 10 mil to 120 mil (250-3000 microns).

Examples of multilayer films in accordance with the invention include, but are not limited to, the following:
PET/tie/PCTFE/tie/nylon-6(SCP)/EVOH/nylon-6/(SCP)/tie/sealant layer,
PETG/tie/PCTFE/tie/nylon-6(SCP+NCP blend)/EVOH/nylon-6(SCP+NCP blend)/tie/sealant layer,
PET/tie/PVdF copolymer/tie/nylon-6(SCP)/EVOH/nylon-6(SCP)/tie/sealant layer,
PET/tie/PVdF copolymer/tie/blend of nylon-6(SCP) and nylon 6/66 (NCP)/EVOH/blend of nylon-6(SCP) and nylon 6/66(NCP)/tie/sealant layer,
nylon-6(SCP)/tie/PVdF copolymer/tie/blend of nylon-6(SCP+NCP)/EVOH/blend of nylon-6(NCP+SCP)/tie/sealant layer,
PVDF copolymer/tie/blend of nylon-6 (SCP) and nylon 6/66/tie/bulk layer/EVA/PVDC/EVA/sealant layer,
PCTFE copolymer/tie/blend of nylon-6 (SCP) and nylon 6/66/tie/bulk layer/EVA/PVDC/EVA/sealant layer,
PET/tie/PVdF copolymer/tie/bulk layer/tie/blend of nylon-6 (SCP) and nylon 6/66 (NCP)/EVOH/blend of nylon-6(SCP) and nylon 6/66(NCP)/tie/sealant layer,
PET/tie/PVdF copolymer/tie/bulk layer/tie/blend of nylon-6(SCP) and nylon 6/66 (NCP)/EVOH/blend of nylon-6(SCP) and nylon 6/66(NCP)tie/shrink layer/sealant layer,
PVdF copolymer/tie/PETG copolymer/tie/bulk layer/tie/blend of nylon-6(SCP) and nylon 6/66 (NCP)/EVOH/blend of nylon-6(SCP) and nylon 6/66(NCP)/tie/shrink layer/sealant layer,
(PETG-tie-PETG-tie)/tie/bulk layer/tie/nylon-6(SCP)/EVOH/nylon-6(SCP)/tie/shrink layer/sealant layer,
(PETG-tie-PETG-tie)/tie/partially cross-linked bulk layer/tie/nylon-6/EVOH/nylon-6/tie/shrink layer/sealant layer,
(PETG-tie-PETG-tie)/tie/bulk layer/tie/nylon-6/EVOH/nylon-6/tie/partially cross-linked shrink layer/sealant layer,
(PETG-tie-PETG-tie)/tie/partially cross-linked bulk layer/tie/nylon-6/EVOH/nylon-6/tie/partially cross-linked shrink layer/sealant layer,
(PETG-tie-PETG-tie)/tie/bulk nano-layer/tie/nylon-6(blend of SCP and NCP)/EVOH/nylon-6(blend of SCP and NCP)/tie/shrink nano-layer/partially cross-linked sealant layer,
(PET-tie-PET-tie/tie/bulk layer/tie/blend of nylon-6(SCP and NCP)/EVOH/blend of nylon-6(SCP and NCP)/tie/shrink layer/sealant layer,
(PETG-tie-PETG-tie-PETG-tie-PETG-tie-PETG-tie)tie/bulklayer/tie/nylon-6 (blend of SCP& NCP)/EVOH/nylon-6(blend of SCP& NCP)/tie/shrink layer/sealant layer,
PET-tie-PETG-tie)/tie/bulk layer/tie/PVDC/EVA/PVDC/tie/shrink layer/sealant layer,
nylon-6(NCP)-tie-nylon-6(NCP)-tie/tie/bulk layer/tie/nylon-6(SCP)/EVOH/nylon-6(SCP)/tie/shrink layer/sealant layer,
nylon-6(NCP)-tie-nylon-6(NCP)-tie)/tie/partially cross-linked bulk layer/tie/nylon-6/EVOH/nylon-6/tie/shrink layer/sealant layer,
nylon-6(NCP)-tie-nylon-6(NCP)-tie)/tie/bulk layer/tie/nylon-6/EVOH/nylon-6/tie/partially cross-linked shrink layer/Sealant layer,
nylon-6(NCP)-tie-nylon-6(NCP)-tie)/tie/partially cross-linked bulk layer/tie/nylon-6/EVOH/nylon-6/tie/partially cross-linked shrink layer/Sealant layer,
nylon-6(NCP)-tie-nylon-6(NCP)-tie)/tie/bulk nano-layer/tie/nylon-6(blend of SCP & NCP)/EVOH/nylon-6(blend of SCP & NCP)/tie/shrink nano-layer/partially cross-linked Sealant layer,
nylon-6 (blend of SCP and NCP)-tie-nylon-6 (blend of SCP& NCP)-tie/tie/bulk layer/tie/blend of nylon-6 (blend of SCP and NCP)/EVOH/blend of nylon-6(SCP and NCP)/tie/shrink layer/Sealant layer,
polyamide-tie-polyamide-tie-polyamide-tie-polyamide-tie/tie/bulk layer/tie/nylon-6 (blend of SCP and NCP)/EVOH/nylon-6 (blend of SCP and NCP)/tie/shrink layer/Sealant layer,
(nylon 6/66-tie-nylon-6/66-tie)/tie/bulk layer/tie/PVDC/EVA/PVDC/tie/shrink layer/Sealant layer,
PCTFE-tie-PCTFE-tie)/tie/bulk layer/tie/(nylon-6(SCP)/EVOH/nylon-6(SCP)tie/shrink layer/sealant layer,
PCTFE-tie-PCTFE-tie/tie/partially cross-linked bulk layer/tie/nylon-6/EVOH/nylon-6/tie/shrink layer/Sealant layer,
PCTFE-tie-PCTFE-tie/tie/bulk layer/tie/nylon-6/EVOH/nylon-6/tie/partially cross-linked shrink layer/Sealant layer,
PCTFE-tie-PCTFE-tie)/tie/partially cross-linked bulk layer/tie/nylon-6/EVOH/nylon-6/tie/partially cross-linked shrink layer/Sealant layer,
PCTFE-tie-PCTFE-tie)/tie/bulk nano-layer/tie/nylon-6(blend of SCP and NCP)/EVOH/nylon-6 (blend of SCP and NCP)/tie/shrink nano-layer/partially cross-linked Sealant layer,
PCTFE-tie-PCTFE-tie/tie/bulk layer/tie/blend of nylon-6(SCP and NCP)/EVOH/blend of nylon-6(SCP and NCP)/tie/shrink layer/Sealant layer and
PP-tie-PP-tie/tie/bulk layer/tie/blend of nylon-6(SCP and NCP)/EVOH/blend of nylon-6(SCP and NCP)/tie/shrink layer/Sealant layer.

A multi-layer film in accordance with the present invention may be made using various established methods. These methods include the use of an annular co-extrusion die as in double bubble, double bubble with annealing and blown processes (air cooled and water cooled), and the use of flat co-extrusion dies as in a cast process, sheet process, extrusion coating process, lamination and extrusion coating lamination. The multi-layer film produced can be laminated on different surfaces (Biaxially-oriented polyethylene terephthalate (BOPET), Biaxially-oriented polyproplylene (BOPP), Biaxially-oriented polyamide (BOPA) films or PVC, PP or APET sheets) by solvent, solvent-less and water-based lamination processes to convert the multi-layer film into bags, pouches, lidding, thermoformed products or stand-alone webs. The multilayer film may also be used to produce containers, bottles, and the like by extrusion blow molding or injection stretch blow moulding processes.

The present multi-layer film may also be made by multilayer extrusion into a tubular bubble form, cooled and collapsed to form a sheet. The subsequently collapsed film may be returned to a second tubular bubble form, stretched radially and longitudinally to produce a biaxially oriented heat shrinkable film, and may be collapsed to again to a further sheet form. The further sheet form may be partially cross-linked by exposure to high energy electrical radiation to improve the sealing properties of the sealant layer.

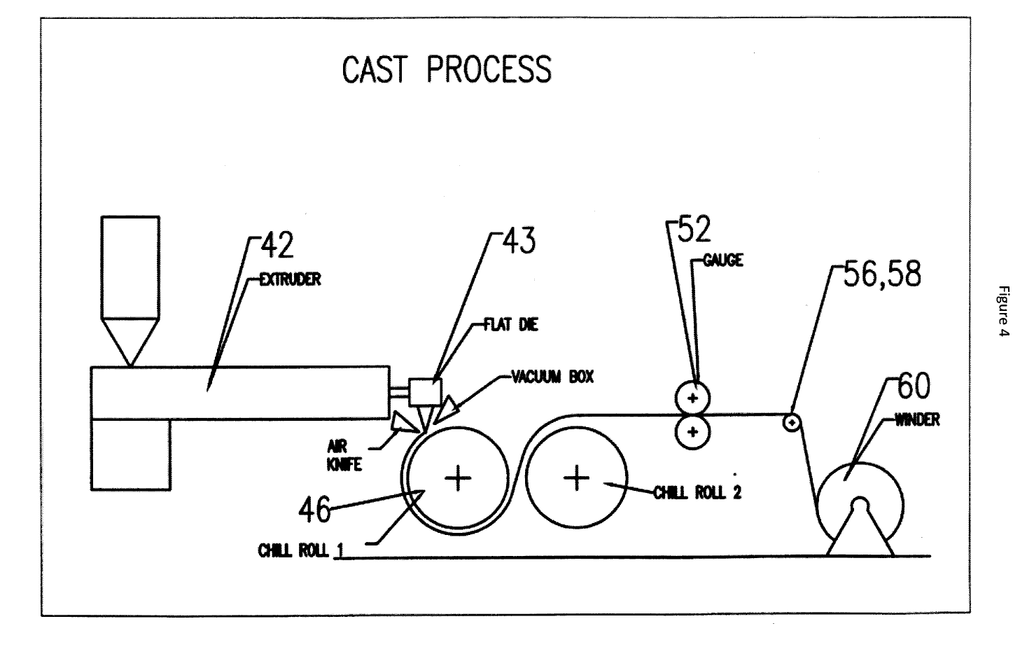

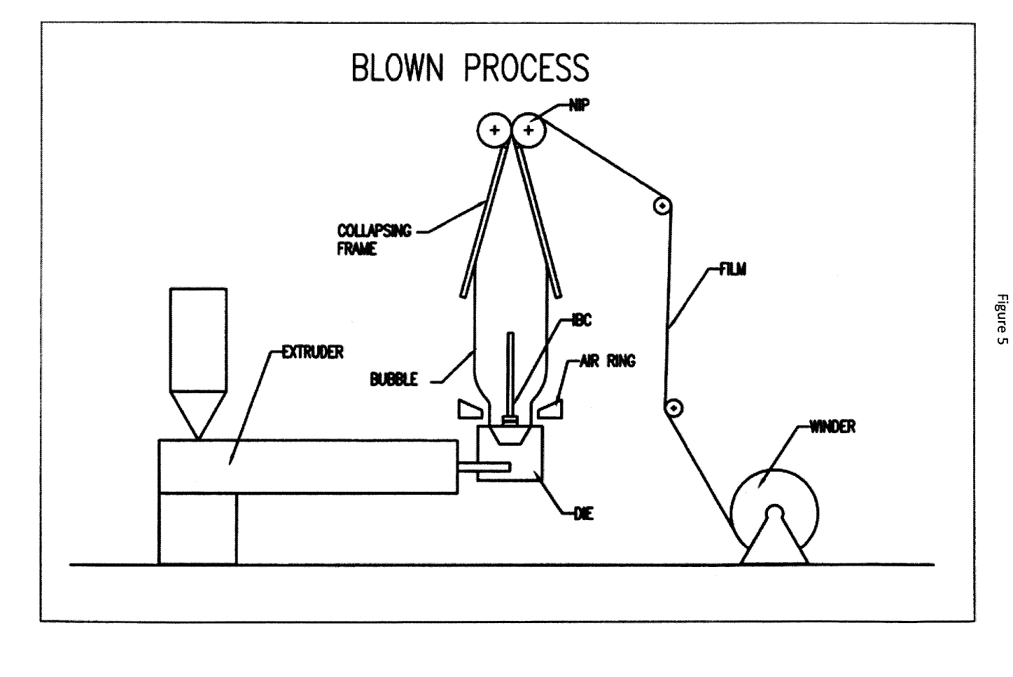

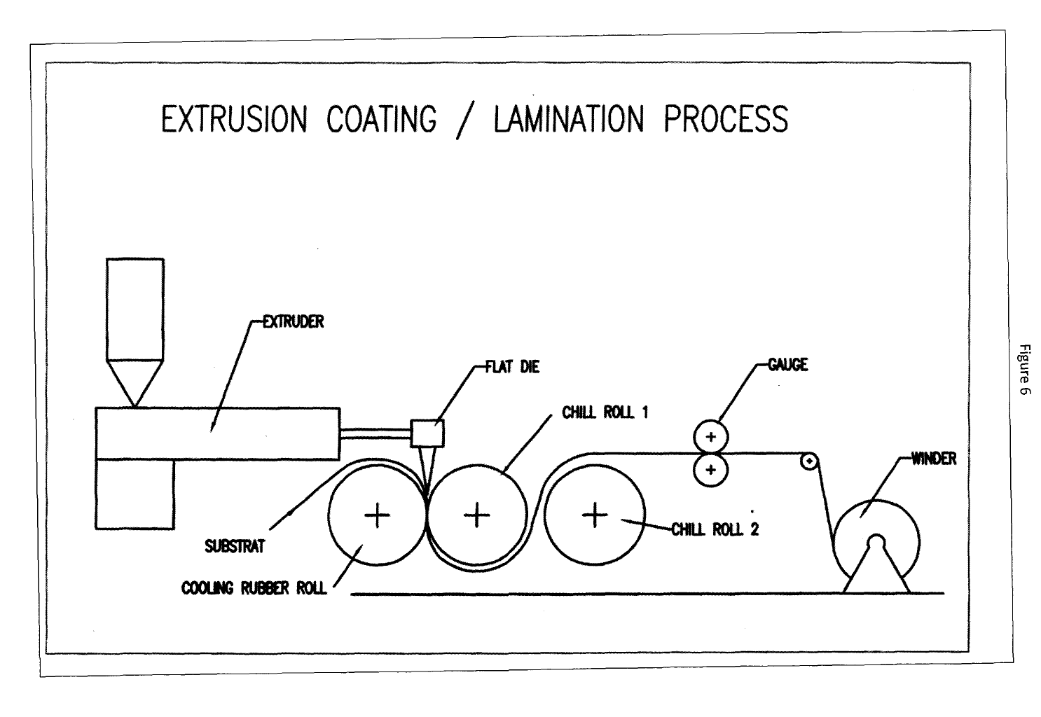

The present multi-layer film may also be made by extruding multi-layers in cast form (FIG. 4), multilayer blown form (FIG. 5) to provide a multilayer plastic film, which may be cooled, or may be laminated (FIG. 6) to a web before cooling.

Embodiments of the invention are described in the following specific examples which are not to be construed as limiting.

### Example 1—Double Bubble Process for Making Multilayer Film

In one of the embodiments of the invention, a multilayer film of 9 layers with excellent moisture, oxygen barrier and mechanical properties has been fabricated. The structure of the multilayer film was: PVDF-copolymer/tie/PETG/tie/PA6 (SCP+NCP)/EVOH/PA 6 (SCP+NCP)/tie/Sealant layer. The outer layer of this film is heat resistant and provides a moisture barrier to protect the inner layers, PETG/PA/EVOH. The total thickness of the multilayer film was from 25 microns to 120 microns, and was preferably from about 30 microns to about 100 microns.

The first outer layer was PVDF, density 1.78 g/cc, viscosity 6 to 10 KPS, melting point 163° C., and a thickness of 2 microns. The bonding tie layer was a PVdF-based copolymer, density 1.6 g/cc. The bulk layer was LLDPE, density 0.912, melt index 1.0. The core oxygen barrier layer was a combination of EVOH (ethylene 38 mole %), density 1.17 g/cc and PA 6 (SCR), density 1.14 g/cc and of PA 6 (NCP)density 1.14 g/co. The subsequent tie layer was an ethylene-based copolymer. The shrink layer was a plastomer, density 0.904 g/cc, melt index 1.0, and the sealant layer was a blend of linear low density LLDPE, density g/cc 0.918, melt index 1.0 and plastomer density 0.902 g/cc and melt index 1.0. The double bubble line (extruder were heated from 160° C. to 200° C., and die was heated at 210° C.). The line was started with 2 MI LDPE in all extruders, with later barrel profile changed slightly (as per resin supplier specification for each resin) and each layer was changed one by one until all desired materials and layer ratios were obtained. The primary speed was from 4.5 meter/min, the tube thickness was 900 microns, the tube was heated in a hot water bath (85° C.) and oriented in MD and TD direction and secondary nip was at 20 m/min to make a final film of 65 microns.

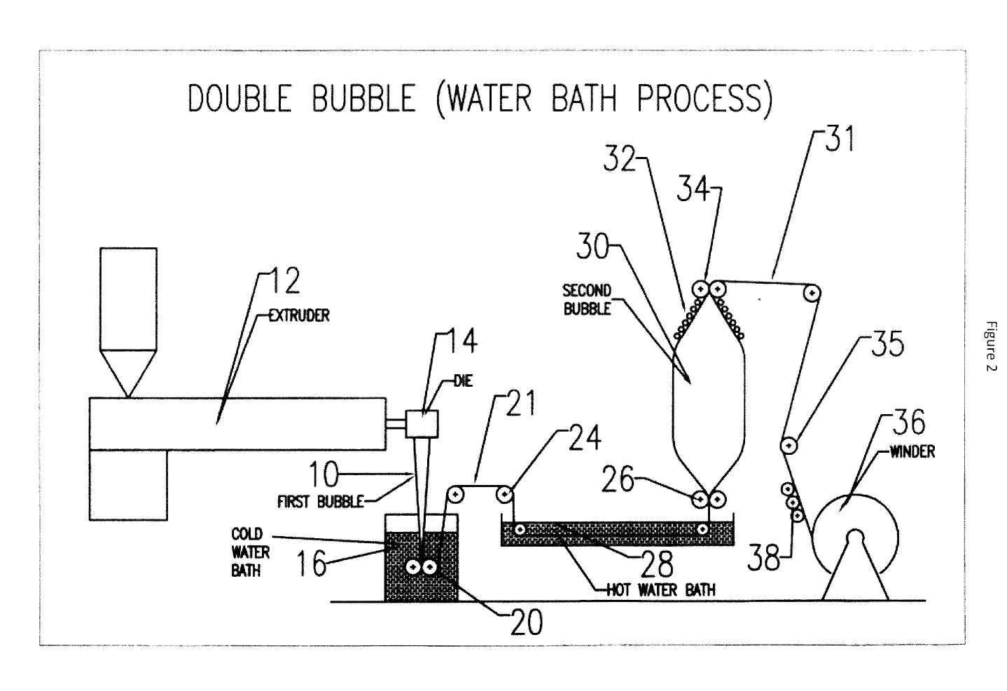

The biaxially oriented heat shrinkable multilayer film was produced by the known double bubble method. Referring to FIG. 2, a tubular nine layer film was produced by using nine extruders 12 (only one is shown). The polymers extruded by extruders 12 were fed to an annular die 14, and tubular primary tube of nine layers extruded downwardly therefrom. The tubular thirteen layer primary tube was cooled in a cold water tank 16 located under the die 14 and containing water at a temperature of about 25° C. or lower. The bubble 10 formed by a multilayer primary tube was squeezed by nip roll 20 in the cold water tank 16 which collapsed the primary tube from bubble form to sheet form. The cold water in the tank 16 quenched the tubular primary tube to maintain the amorphous state of the plastic material and to lower the temperature thereof so that substantially no crystalline growth occurred in the polymer tube which would inhibit the subsequent process of orientation.

The collapsed primary tube 21 from the cold water tank 16 was passed over idler rolls 24 and through a pair of nip rolls 26. The collapsed film 21 was then passed from the nip rolls 26 through a water heating section 28 and blown to form a second bubble 30, which was subsequently collapsed by a collapsing frame 32. The collapsed film 31 was then passed through a pair of nip rolls 34, which were rotated at three to five times faster than nip roll 26, with the air in the bubble 30 being entrapped therein by the rolls 26, 34. This resulted in biaxial orientation of the film lengthwise (MD) and breadthwise (TD). The collapsed film 31 was then passed over further idler rolls 35 and wound in the form of a roll 36.

The collapsed film was then passed through an annealing station 38 which stabilized the film to prevent shrinkage on the rolls 36. The bi-axially oriented, heat shrinkable film may be slit to remove trim, if desired.

### Example 2—Double Bubble Process for Making Multilayer Film

In another embodiment of the invention, a multilayer film (13 layers) with excellent moisture, oxygen barrier and mechanical properties was fabricated. The structure of the multilayer film is: PA6/66-tie1-PA6/66-tie2/tie/bulk layer/tie/PVDC/EVA/PVDC/tie/shrink layer/sealant layer. The first outer micro-layer was PA666, melting point 195° C., density 1.2 g/cc, and tie1/2 layer was LLDPE-maleic anhydride. The outer microlayer had a thickness of about 2 microns. The bonding tie layer was an ethylene-based copolymer, having a melt index of 2.7 and density of 0.90 g/cc. The bulk layer was VLDPE, with a density of 0.912 and melt index of 1.0. The core oxygen and moisture barrier layer of PVDC (VDC content—98%), MA-based copolymer, EVA 2 MI, VA 25-28%. Each PVDC layer was 2 to 4 microns, while the EVA layer was 2 to 3 microns. The tie layer was an ethylene-based copolymer. The shrink layer was a plastomer, density 0.902 g/cc, melt index 1.0. The sealant layer was a blend of ULDPE, density 0.912, melt index 1.0 and plastomer density 0.902 and melt index 1.0.

The biaxially oriented heat shrinkable multilayer film was produced by the double bubble method, illustrated in FIG. 2. The tubular thirteen layer film was produced by using eleven extruders as described in Example 1. The polymers were extruded by extruders 12 (only 1 extruder is shown) were fed to an annular die 14, and tubular primary tube of thirteen layers extruded downwardly therefrom. The tubular thirteen layer primary tube was cooled in a cold water tank 16 located under the die 14 and containing water at a temperature of about 25° C. or lower. The bubble 10 formed by a multilayer primary tube was squeezed by nip roll 20 in the cold water tank 16 which collapsed the primary tube from bubble form to sheet form. The cold water in the tank 16 quenched the tubular primary tube to maintain the amorphous state of the plastic material and to lower the temperature thereof so that substantially no crystalline growth could occur in the polymer tube which would inhibit the subsequent process of orientation.

The collapsed primary tube 21 from the cold water tank 16 was passed over idler rolls 24 and through a pair of nip rolls 26 (at a speed depending upon thickness of primary tube, layflat and material, for example, primary nip can be rotated 2 m/min to 90 m/min). The collapsed film 21 was then passed from the nip rolls 26 through a water heating section 28 and blown to form a second bubble 30, which was subsequently collapsed by a collapsing frame 32. The collapsed film 31 was then passed through a pair of nip rolls 34, which were rotated at three to five times faster than nip rolls 26, with the air in the bubble 30 being entrapped therein by the rolls 26, 34. This resulted in biaxial orientation of the film lengthwise (MD) and breadthwise (TD). The collapsed film 31 was then passed over further idler rolls 34 and wound in the form of a roll 36.

The collapsed film was then passed by an annealing station 38 (annealing temperature depends upon polymer material fabricating the film, and could be from 50° C. to 140° C.) to stabilize the film and to prevent shrinkage from the rolls 36. The bi-axially oriented, heat shrinkable film may be slit to remove trim if desired.

The resulting bi-axially oriented heat shrinkable film had a physical thickness of 40 microns. The film exhibited excellent oxygen, moisture and mechanical properties. The film was flexed 100 times without any visible mechanical cracks appearing. The film was tested for shrinkage and showed an excellent shrinkage of 30% in TD and 30% in MD at 90° C.

### Example 3: Double Bubble Process with Annealing for Making Multilayer Film

In another embodiment, a multilayer film (13 layers) with excellent moisture, oxygen barrier and mechanical properties was fabricated having the following structure: PETG1-tie1-PETG2-tie2/tie/bulk layer/tie/(PA6(blend of SCP & NCP)/EVOH/PA6(blend of SCP& NCP)/tie/shrink layer/sealant layer. The first outer layer (in micro-layer configuration) was PETG, density 1.33 g/cc, intrinsic viscosity 0.79 dl/g, melting point 225° C. and tie % resin was an ethylene-based copolymer, melt index 2.7, density 0.90 g/cc. The thickness of the 4 micro-layers was 2 microns. The bonding tie layer was an ethylene-based copolymer, melt index 2.7, density 0.90 g/cc. The bulk layer was LLDPE, density 0.916, melt index 1.0. One micro-layer block of PA6 (homopolymer nylon), melting point 220° C., tie layer was LLDPE-maleic anhydride. The core oxygen barrier layer was a combination of EVOH (ethylene 38 mole %), density 1.17 g/cc and PA 6 (SCR), density 1.14 g/cc and of PA 6 (NCP)density 1.14 g/cc. The subsequent tie layer was an ethylene-based copolymer. The shrink layer was a plastomer, density 0.902 g/cc, melt index 1.2, and the sealant layer was a blend of linear low density LLDPE, density g/cc 0.918, melt index 1.0 and plastomer density 0.902 g/cc and melt index 1.0.

The first outer layer (in micro-layer configuration) was PETG, density 1.33 g/cc, intrinsic viscosity 0.79 dl/g, melting point 225° C. and tie ½ resin was an ethylene-based copolymer, melt index 2.7, density 0.90 g/cc. The thickness of the 4 micro-layers was 2 microns. The bonding tie layer was an ethylene-based copolymer, melt index 2.7, density 0.90 g/cc. The bulk layer was LLDPE, density 0.916, melt index 1.0. One micro-layer block of PA6 (homopolymer nylon), melting point 220° C., tie layer was LLDPE-maleic anhydride. The core oxygen barrier layer was a combination of EVOH (ethylene 38 mole %), density 1.17 g/cc and PA 6 (SCR), density 1.14 g/cc and of PA 6 (NCP)density 1.14 g/cc. The subsequent tie layer was an ethylene-based copolymer. The shrink layer was a plastomer, density 0.902 g/cc, melt index 1.2, and the sealant layer was a blend of linear low density LLDPE, density g/cc 0.918, melt index 1.0 and plastomer density 0.902 g/cc and melt index 1.0.

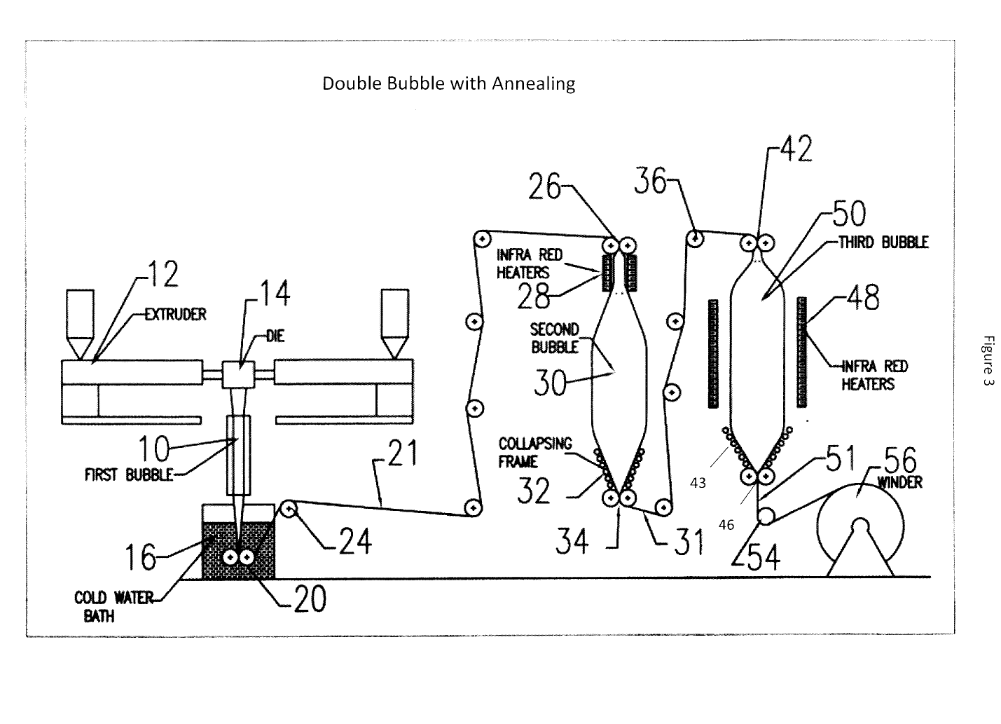

The multilayer film was produced using the double bubble method with annealing as shown in FIG. 3, using eleven extruders 12 (only one is shown). The polymers were sequentially extruded by extruders 12, fed to an annular die 14, and primary tube of thirteen layers was extruded downwardly therefrom. The thirteen layer primary tube was cooled in a cold water tank 16 located under the die 14 and containing water at a temperature of about 25° C. or lower. The bubble 10 formed by a multilayer primary tube was squeezed by nip roll 20 in the cold water tank 16 to collapse the film from bubble form to sheet form 21. The cold water in the tank 16 quenched the primary tube to maintain the amorphous state of the plastic material and to lower the temperature thereof so that substantially no crystalline growth occurred in the polymers of the primary tube which would inhibit the subsequent process of orientation.

The collapsed primary tube 21 was passed over idler rolls 24 and through a pair of nip rolls 26. The collapsed film 21 was then passed from the nip rolls 26 through an infrared heating section 28 and blown to form a second bubble 30, which was subsequently collapsed by a collapsing frame 32. The collapsed film 31 was then passed through a pair of nip rolls 34, which were rotated at three to five times faster than nip rolls 26, with the air in the bubble 30 being entrapped therein by the rolls 26, 34 (nip rollers are opened and air is introduced by blowing air using air nozzle and then nip is closed to trap air between primary and secondary nip rollers). This resulted in biaxial orientation of the film lengthwise (MD) and breadthwise (ID). The collapsed film 31 was then passed over idler rolls 36 and then from nip rolls 42 through an infrared heating section 48 and blown to form a third bubble 50 for annealing, which was subsequently collapsed by a collapsing frame 43. The collapsed film 51 was then passed through a pair of nip rolls 46, which were rotated slightly slower than nip roll 42 (nip speed depends upon the film structure, for example, it could be from 5 m/min to 500 m/min) with the air in the bubble 50 being entrapped therein by the rolls 42, 46. This results in annealing of film 51. The collapsed film 51 is then passed over further idler rolls 54 and wound in the form of a roll 56. The biaxially oriented heat stabilized low shrink film 51 may be slit to remove trim if desired (line speed depends upon the process conditions and film structure; the film is annealed at 110° C.).

The resulting bi-axially oriented heat shrinkable film had a physical thickness of 40 microns and showed excellent oxygen, moisture and mechanical properties. The film was flexed 100 times without any visible mechanical cracks appearing. The film was tested for shrinkage and showed a low shrinkage (30%) at 90° C.

### Example 4: Double Bubble Process with Annealing for Making Multilayer Film

A nine layer biaxially oriented shrink plastic film was prepared by the double bubble (with annealing) blown method as described in Example 3. The structure of the multilayer film was: PETG/tie/PVdF-copolymer layer/tie/(PA6(SCP+NCP)/EVOH/PA6(SCP+NCP)/tie/Sealant layer. The first outer layer was PETG, density 1.33 g/cc, intrinsic viscosity 0.79 dl/g, melting point 225° C. The thickness of the outer layer was 1.5 microns. The tie layer was PVDF-maleic anhydride and its thickness was 1.5 microns. The next layer was PVdF copolymer, melting point 145° C., density 1.8 g/cc, thickness 1.5 microns, and the tie layer was PVdF-maleic anhydride with a thickness of 1.5 microns. The next layer was a blend of SCP (PA6) and NCP (PA6) having a melting point of 220° C., and a density of 1.14 g/cc. The core oxygen barrier layer was EVOH (ethylene 38 mole %), density 1.17 g/cc; and the tie layer was an ethylene-based copolymer, melt index 2.7, density 0.90 g/cc; the sealant layer was a blend of linear low density LLDPE, density 0.918 g/cc, melt index 1.0, and plastomer having a density of 0.902 g/cc. The resulting bi-axially oriented heat shrinkable film has a physical thickness of 55 microns and showed excellent oxygen, moisture and mechanical properties. The film was flexed 100 times without any visible mechanical cracks appearing. The film was tested for shrinkage and showed a low shrinkage (10%) at 90° C.

### Example 5: Cast Film Process for Making a Multilayer Film

A multilayer film having the structure: PA6(NCP)1-tie1-PA6(NCP)2-tie2/tie/bulklayer/tie/(PA6(SCP)/EVOH/PA6(SCP)tie/bulk layer/sealant layer was produced by a cast film process as illustrated in FIG. 4. The total thickness of the multilayer cast film was between about 120 microns to about 250 microns. In the cast process, melt temperature of all polymers was in the range of 230° C. to 255° C., the line speed was in 10 m/min to 25 m/min (depending upon the thickness), and the cast sheet was cooled by a set of 2 chill rolls.

A cast sheet of thirteen layers was produced by using eleven extruders 42 (only one is shown). The polymers extruded by the extruder 42 were fed to a cast film die 43, and the cast film was extruded downwards therefrom over a chill roll 46 which cools the film. The cast sheet was passed though nip rolls 52 and idler rolls 56, 58 and was wound onto roll 60.

1. A multilayer film comprising:
a core barrier layer having an outer side and an inner side, said core barrier layer comprising one or more barrier polymers that exhibit moisture and/or oxygen barrier properties, wherein said barrier polymer is optionally coupled to a slow crystallizing polyamide or a polymer blend thereof;
an outer layer bonded to the outer side of the core barrier layer comprising a rigid polymer having an inherent viscosity (IV) in the range of about 3.2 to 4.7, wherein the outer layer optionally comprises slow crystallizing polymer (SCP) or a polymer blend thereof; and
a sealant layer bonded to the inner side of the core barrier layer comprising one or more polyolefins sufficient to provide a seal.

2. The multilayer film according to claim 1, wherein the outer layer comprises at least one material selected from the group consisting of polyester, glycol-modified polyester (PETG), and a polyamide (PA) selected from nylon-6, nylon-6,6, nylon-6/66, nylon-11, nylon-12, nylon-4,6, nylon 6/9, nylon-6/10, nylon 6/12, nylon terpolymer, aromatic nylon, amorphous nylon, nylon-6 slow crystallizing polymer and a blend of nylon-6 slow crystallizing polymer with normal crystallizing polyamide.

3. The multilayer film according to claim 1, wherein the outer layer comprises at least one material selected from the group consisting of polychlorotrifluoroethene (PCTFE), polyvinylidene fluoride (PVDF) copolymers, cyclic olefin copolymer (COC), polyolefin, blends of COC with polyolefin, polyethylene or polypropylene, polystyrene, styrene butadiene copolymer, poly(methylmethacrylate), polyethylene terpthalate (PET), polyethylene naphthalate (PEN), polybutylene terephthalate, polylactic acid and mixtures thereof.

4. The multilayer film according to claim 1, wherein the outer layer comprises at least one material selected from the group consisting of low density polyethylene, linear low density polyethylene, metallocene-based linear low density polyethylene, polypropylene, copolymers of polypropylene, high-density polyethylene, ionomers, and mixtures thereof.

5. The multilayer film according to claim 1, wherein the outer layer comprises a rigid polymer having an inherent viscosity (IV) in the range of about 3.2 to 4.7 (96% sulfuric acid, 1 g/100 ml) and a soft polymer having a melt index of from about 0.5 MI to 6 MI.

6. The multilayer film according to claim 5, wherein the rigid polymer is selected from the group consisting of polyester, glycol-modified polyester (PETG), nylon-6, nylon-6,6, nylon-6/66, nylon-11, nylon-12, nylon-4,6, nylon 6/9, nylon-6/10, nylon 6/12, nylon terpolymer, aromatic nylon, amorphous nylon, nylon-6 slow crystallizing polymer, a blend of nylon-6 slow crystallizing polymer (SCP) with normal crystallizing polyamide (NCP), polychlorotrifluoroethene (PCTFE), polyvinylidene fluoride (PVDF) copolymers, cyclic olefin copolymer (COC), polyolefin, blends of COC with polyolefin, polyethylene or polypropylene, polystyrene, styrene butadiene copolymer, poly(methylmethacrylate), amorphous polyethylene terpthalate (APET), polyethylene naphthalate (PEN), polybutylene terephthalate, polylactic acid, low density polyethylene, linear low density polyethylene, metallocene-based linear low density polyethylene, polypropylene, copolymers of polypropylene, high-density polyethylene, ionomers, and mixtures thereof.

7. The multilayer film according to claim 5, wherein the soft polymer is selected from the group consisting of maleic anhydride grafted onto linear low density polyethylene (LLDPE), low density polyethylene (LDPE), ethylene vinyl acetate (EVA) or EMA (ethylene methacrylate), optionally blended with polyolefin such as polypropylene, polyethylene, LLDPE, metallocene LLDPE (mLLDPE), high density polyethylene (HDPE), COC, plastomer or elastomers.

8. The multilayer film according to claim 1, wherein the outer layer has a thickness in the range of from about 0.5 to about 10 microns.

9. The multilayer film according to claim 1, comprising a bulk layer between the outer layer and the core barrier layer, said bulk layer comprising one or more polyolefins having a density in the range of about 0.88 g/cc to 1.04 g/cc, and a melt index (MI) of from about 0.5 MI to 10 MI.

10. The multilayer film according to claim 9, wherein the bulk layer comprises an elastomer, plastomer, polypropylene homopolymer, copolymer, or terpolymer; styrene-based copolymers, polystyrene, styrene block copolymer (SBC), low density polyethylene (LDPE), cyclic olefin copolymer (COC), an acid polymer, high density polyethylene (HDPE), linear low density polyethylene (LLDPE), metallocene LLDPE (mLLDPE), very low density polyethylene (VLDPE), metallocene polyethylene (mPE), high density polyethylene (HDPE), single site metallocene catalyst (SSC) based LLDPE, ethylene-vinyl acetate (EVA), ethylene methacrylate (EMA), octene-LL, hexene-LL, butene-LL, ionomer, or blends of any of these polymers.

11. The multilayer film according to claim 9, wherein the bulk layer has a thickness in the range of about 1 to 50 microns.

12. The multilayer film according to claim 1, wherein the core barrier layer comprises a polymer selected from the group consisting of a polyamide, EVOH or polyvinylidene chloride.

13. The multilayer film according to claim 1, wherein the core barrier layer has a thickness from about 1 to about 25 microns.

14. The multilayer film according to claim 1, wherein the core barrier layer additionally includes slow crystallizing polyamide polymer, or a blend of a slow crystallizing polyamide polymer with nylon-6, nylon-6,6, nylon-6/66, nylon-11, nylon-12, nylon-4,6, nylon 6/9, nylon-6/10, nylon 6/12, nylon terpolymer, aromatic nylon or amorphous nylon.

15. The multilayer film according to claim 1, wherein the sealant layer comprises one or more polyolefins having a seal strength from about 2 to 20 lbs/inch and a density of 0.88 g/cc to 0.920 g/cc.

16. The multilayer film according to claim 15, wherein the sealant layer comprises one or more elastomers, plastomers, polyethelene (PE), polyolefin (PO), polypropylene homopolymer, copolymer, or terpolymer; low density polyethylene (LDPE), medium density polyethylene (MDPE), linear low density polyethylene (LLDPE), metallocene LLDPE (mLLDPE), very low density polyethylene (VLDPE), metallocene polyethylene (mPE), high density polyethylene (HDPE), single site metallocene catalyst (SSC) based LLDPE, ethylene-vinyl acetate (EVA), ethylene methacrylate (EMA), ethyelene acrylic acid (EAA), ethylene methacrylic acid, ethylene methyl acrylate copolymer (EMAC), salts of ethylene acrylic acid or methacrylic acid, acid co-polymers, ionomers with a melt index (MI) of from about 0.5 MI to 10 MI, and mixtures thereof.

17. The multilayer film according to claim 15, wherein the sealant layer has a thickness in the range of about 5 to 50 microns.

18. The multilayer film according to claim 1, comprising a shrink layer between the core barrier layer and the sealant layer.

19. The multilayer film according to claim 18, wherein the shrink layer comprises one or more polyolefins having a density of 0.88 g/cc to 0.92 g/cc, and which exhibit at least about 10% to 50% shrinkage at 90° C.

20. The multilayer film according to claim 18, wherein the shrink layer comprises one or more elastomers, plastomers, polypropylene, polypropylene copolymer or polypropylene terpolymer, low density polyethylene (LDPE), linear low density polyethylene (LLDPE), metallocene LLDPE (mLLDPE), very low density polyethylene (VLDPE), metallocene polyethylene (mPE), single site metallocene catalyst (SSC) based LLDPE, ethylene-vinyl acetate (EVA), ethylene methacrylate (EMA), acid polymers, network polymers, ionomers with a melt index (MI) of from about 0.5 MI to 10 MI, or mixtures thereof.

21. The multilayer film according to claim 18, wherein the shrink layer has a thickness in the range of about 1 to 50 microns.

22. The multilayer film according to claim 1, wherein layers of the film may be bonded with a tie layer comprising maleic anhydride grafted onto linear low density polyethylene (LLDPE), low density polyethylene (LDPE), ethylene vinyl acetate (EVA) or EMA (ethylene methacrylate), optionally blended with polypropylene, polyethylene, LLDPE, metallocene LLDPE (mLLDPE), high density polyethylene (HDPE), COC, plastomer or elastomers.

23. The multilayer film according to claim 22, wherein each tie layer has a thickness in the range of about 2 to 20 microns.

24. The multilayer film according to claim 1, wherein the total thickness of said film is in the range of about 10 to about 300 microns.

25. A multilayer film selected from the group consisting of:
PET/tie/PCTFE/tie/nylon-6(SCP)/EVOH/nylon-6/(SCP)/tie/sealant layer,
PETG/tie/PCTFE/tie/nylon-6(SCP+NCP blend)/EVOH/nylon-6(SCP+NCP blend)/tie/sealant layer,
PET/tie/PVdF copolymer/tie/nylon-6(SCP)/EVOH/nylon-6(SCP)/tie/sealant layer,
PET/tie/PVdF copolymer/tie/blend of nylon-6(SCP) and nylon 6/66 (NCP)/EVOH/blend of nylon-6(SCP) and nylon 6/66(NCP)/tie/sealant layer,
nylon-6(SCP)/tie/PVdF copolymer/tie/blend of nylon-6(SCP+NCP)/EVOH/blend of nylon-6(NCP+SCP)/tie/sealant layer,
PVDF copolymer/tie/blend of nylon-6 (SCP) and nylon 6/66/tie/bulk layer/EVA/PVDC/EVA/sealant layer,
PCTFE copolymer/tie/blend of nylon-6 (SCP) and nylon 6/66/tie/bulk layer/EVA/PVDC/EVA/sealant layer,
PET/tie/PVdF copolymer/tie/bulk layer/tie/blend of nylon-6 (SCP) and nylon 6/66 (NCP)/EVOH/blend of nylon-6(SCP) and nylon 6/66(NCP)/tie/sealant layer,
PET/tie/PVdF copolymer/tie/bulk layer/tie/blend of nylon-6(SCP) and nylon 6/66 (NCP)/EVOH/blend of nylon-6(SCP) and nylon 6/66(NCP)/tie/shrink layer/sealant layer,
PVdF copolymer/tie/PETG copolymer/tie/bulk layer/tie/blend of nylon-6(SCP) and nylon 6/66 (NCP)/EVOH/blend of nylon-6(SCP) and nylon 6/66(NCP)/tie/shrink layer/sealant layer,
(PETG-tie-PETG-tie)/tie/bulk layer/tie/nylon-6(SCP)/EVOH/nylon-6(SCP)/tie/shrink layer/sealant layer,
(PETG-tie-PETG-tie)/tie/partially cross-linked bulk layer/tie/nylon-6/EVOH/nylon-6/tie/shrink layer/sealant layer,
(PETG-tie-PETG-tie)/tie/bulk layer/tie/nylon-6/EVOH/nylon-6/tie/partially cross-linked shrink layer/sealant layer,
(PETG-tie-PETG-tie)/tie/partially cross-linked bulk layer/tie/nylon-6/EVOH/nylon-6/tie/partially cross-linked shrink layer/sealant layer,
(PETG-tie-PETG-tie)/tie/bulk nano-layer/tie/nylon-6(blend of SCP and NCP)/EVOH/nylon-6(blend of SCP and NCP)/tie/shrink nano-layer/partially cross-linked sealant layer,
(PET-tie-PET-tie/tie/bulk layer/tie/blend of nylon-6(SCP and NCP)/EVOH/blend of nylon-6(SCP and NCP)/tie/shrink layer/sealant layer,
(PETG-tie-PETG-tie-PETG-tie-PETG-tie-PETG-tie)tie/bulklayer/tie/nylon-6 (blend of SCP& NCP)/EVOH/nylon-6(blend of SCP& NCP)/tie/shrink layer/sealant layer,
PET-tie-PETG-tie)/tie/bulk layer/tie/PVDC/EVA/PVDC/tie/shrink layer/sealant layer,
nylon-6(NCP)-tic-nylon-6(NCP)-tie/tie/bulk layer/tie/nylon-6(SCP)/EVOH/nylon-6(SCP)/tie/shrink layer/sealant layer,
nylon-6(NCP)-tie-nylon-6(NCP)-tie)/tie/partially cross-linked bulk layer/tie/nylon-6/EVOH/nylon-6/tie/shrink layer/sealant layer,
nylon-6(NCP)-tie-nylon-6(NCP)-tie)/tie/bulk layer/tie/nylon-6/EVOH/nylon-6/tie/partially cross-linked shrink layer/Sealant layer,
nylon-6(NCP)-tie-nylon-6(NCP)-tie)/tie/partially cross-linked bulk layer/tie/nylon-6/EVOH/nylon-6/tie/partially cross-linked shrink layer/Sealant layer,
nylon-6(NCP)-tie-nylon-6(NCP)-tie)/tie/bulk nano-layer/tie/nylon-6(blend of SCP & NCP)/EVOH/nylon-6(blend of SCP & NCP)/tie/shrink nano-layer/partially cross-linked Sealant layer,
nylon-6 (blend of SCP and NCP)-tie-nylon-6 (blend of SCP& NCP)-tie/tie/bulk layer/tie/blend of nylon-6 (blend of SCP and NCP)/EVOH/blend of nylon-6(SCP and NCP)/tie/shrink layer/Sealant layer,
polyamide-tie-polyamide-tie-polyamide-tie-polyamide-tie/tie/bulk layer/tie/nylon-6 (blend of SCP and NCP)/EVOH/nylon-6 (blend of SCP and NCP)/tie/shrink layer/Sealant layer,
(nylon 6/66-tie-nylon-6/66-tie)/tie/bulk layer/tie/PVDC/EVA/PVDC/tie/shrink layer/Sealant layer,
PCTFE-tie-PCTFE-tie)/tie/bulk layer/tie/(nylon-6(SCP)/EVOH/nylon-6(SCP)tie/shrink layer/sealant layer,
PCTFE-tie-PCTFE-tie/tie/partially cross-linked bulk layer/tie/nylon-6/EVOH/nylon-6/tie/shrink layer/Sealant layer,
PCTFE-tie-PCTFE-tie/tie/bulk layer/tie/nylon-6/EVOH/nylon-6/tie/partially cross-linked shrink layer/Sealant layer,
PCTFE-tie-PCTFE-tie)/tie/partially cross-linked bulk layer/tie/nylon-6/EVOH/nylon-6/tie/partially cross-linked shrink layer/Sealant layer,
PCTFE-tie-PCTFE-tie)/tie/bulk nano-layer/tie/nylon-6(blend of SCP and NCP)/EVOH/nylon-6 (blend of SCP and NCP)/tie/shrink nano-layer/partially cross-linked Sealant layer,
PCTFE-tie-PCTFE-tie/tie/bulk layer/tie/blend of nylon-6(SCP and NCP)/EVOH/blend of nylon-6(SCP and NCP)/tie/shrink layer/Sealant layer and
PP-tie-PP-tie/tie/bulk layer/tie/blend of nylon-6(SCP and NCP)/EVOH/blend of nylon-6(SCP and NCP)/tie/shrink layer/Sealant layer.
